(19) United States
(12) Patent Application Publication
(10) Pub. No.: US 2018/0324933 A1
(43) Pub. Date: Nov. 8, 2018

(54) Lighting Control With Location Based Communication

(71) Applicant: Eaton Intelligent Power Limited, Dublin (IE)

(72) Inventors: Geoffrey Granville Hammett, Norcross, GA (US); Leonardo Enrique Matute, Atlanta, GA (US); Michael Alan Lunn, Peachtree City, GA (US); Bruce Andrew Carl Douglas, Fayetteville, GA (US)

(21) Appl. No.: 15/974,508

(22) Filed: May 8, 2018

Related U.S. Application Data
(60) Provisional application No. 62/503,190, filed on May 8, 2017.

(51) Int. Cl. H05B 37/02; H04W 76/15; G06K 19/07; G06K 19/077

(52) U.S. Cl. CPC H05B 37/0272; H05B 37/0227; H04W 4/029; G06K 19/0723; G06K 19/07758; H04W 76/15

(57) ABSTRACT

A multi-network gateway device includes a lighting network interface circuit configured to communicate with lighting devices using first wireless signals compliant with a first communications standard. The gateway device further includes a location-based network interface circuit configured to communicate with asset tags using second wireless signals compliant with a second communications standard that is different from the first communications standard. The gateway device also includes a processor configured to control the lighting network interface circuit to transmit a lighting control command based on identification information received wirelessly by the location-based network interface circuit.

### RELATED APPLICATION

The present application claims priority under 35 U.S.C. § 119(e) to U.S. Provisional Patent Application No. 62/503,190, titled “Lighting Control With Location Based Communication,” and filed on May 8, 2017. The foregoing application is incorporated herein by reference in its entirety.

### TECHNICAL FIELD

The present disclosure relates generally to lighting control devices and lighting systems, and more particularly to lighting control devices and lighting systems in relations to location-based operations.

### BACKGROUND

Lighting control and status information may be communicated among devices of a wireless communication network of lighting devices. For example, a lighting command may be sent to a lighting fixture from a wall station through a lighting network controller device. As another example, status information may be sent from a sensor to the controller device. Location based systems generally operate on an independent communication network and generally require a separate controller device. The controller devices of the two networks may also communicate with respective remote management centers independently. In some applications, a solution that simplifies installation, configuration, administration, and maintenance of the two networks and that enables interoperability between the two networks may be desirable.

### SUMMARY

The present disclosure relates generally to lighting control devices and lighting systems, and more particularly to lighting control devices and lighting systems in relation to location-based operations. In an example embodiment, a multi-network gateway device includes a lighting network interface circuit configured to communicate with lighting devices using first wireless signals compliant with a first communications standard. The gateway device further includes a location-based network interface circuit configured to communicate with asset tags using second wireless signals compliant with a second communications standard that is different from the first communications standard. The gateway device also includes a processor configured to control the lighting network interface circuit to transmit a lighting control command based on identification information received wirelessly by the location-based network interface circuit.

In another example embodiment, a multi-network system includes a gateway device having a lighting network interface and a location-based network interface. The multi-network system further includes a lighting device that wirelessly communicates with the gateway device using first wireless signals compliant with a first communications standard. The multi-network system also includes an asset tag that wirelessly communicates with the gateway using second device wireless signals compliant with a second communications standard that is different from the first communications standard. The gateway device transmits a lighting control command to the lighting device via the lighting network interface based on identification information wirelessly received by the gateway device via the location-based network interface.

In another example embodiment, a method of communication by a multi-network gateway device includes receiving, by the multi-network gateway device, identification information of an asset tag over a first communication network that is based on first wireless signals that are compliant with a first communications standard. The method further includes identifying, by the multi-network gateway device, one or more lighting devices based on the identification information. The method also includes transmitting, by the multi-network gateway device, a lighting control command to the one or more lighting devices over a second communication network that is based on second wireless signals that are compliant with a second communications standard that is different from the first communications standard.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a multi-network gateway device according to an example embodiment;

FIG. 2 illustrates a multi-network system that includes the multi-network gateway device of FIG. 1 according to an example embodiment;

FIG. 3 illustrates a multi-network system that includes the multi-network gateway device of FIG. 1 according to another example embodiment; and

FIG. 4 illustrates a method of operating the multi-network gateway device and systems of FIGS. 1-3 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DETAILED DESCRIPTION OF THE EXAMPLE EMBODIMENTS

In the following paragraphs, example embodiments will be described in further detail with reference to the figures. In the description, well-known components, methods, and/or processing techniques are omitted or briefly described. Furthermore, reference to various feature(s) of the embodiments is not to suggest that all embodiments must include the referenced feature(s).

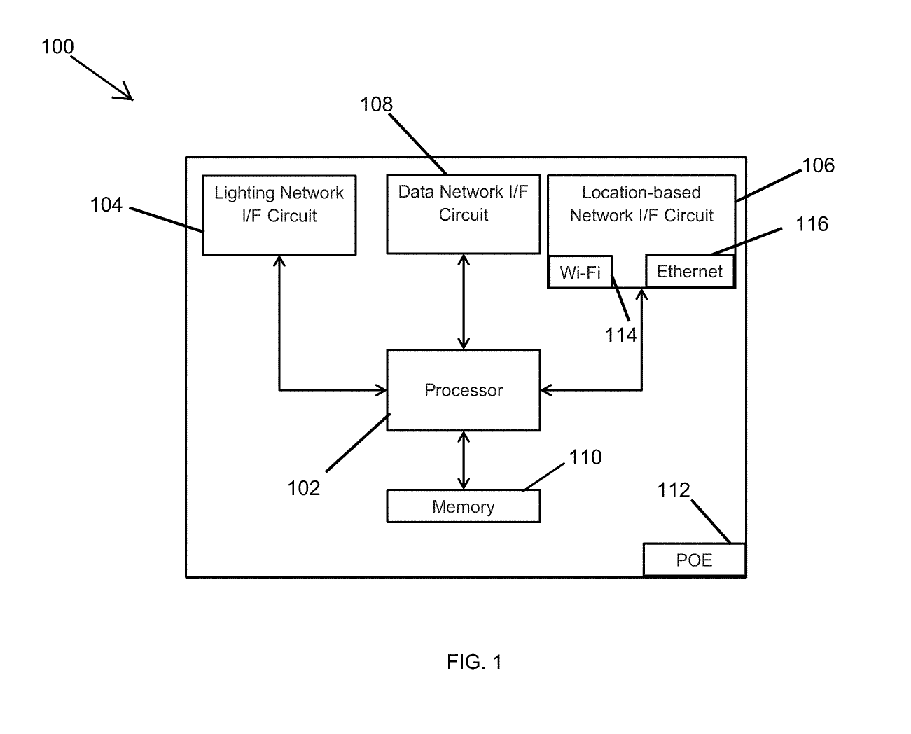

Turning now to the figures, particular example embodiments are described. FIG. 1 illustrates a multi-network gateway device 100 according to an example embodiment. In some example embodiments, the gateway device 100 includes a processor (e.g., a microprocessor), a lighting network interface circuit 104, a location-based network interface circuit 106, and a data network interface circuit 108. The gateway device 100 may also include a memory device (e.g., a static random access memory device) 110 and a Power over Ethernet circuit (PoE) 112. The lighting network interface circuit 104 serves as the lighting network interface of the gateway device 100. The location-based network interface circuit 106 serves as the location-based network interface of the gateway device 100. The data network interface circuit 108 serves as the data network interface of the gateway device 100. The location-based network interface circuit 106 may enable the gateway device 100 to operate as a real-time Locating Systems (RTLS) device and/or as a Location-Based Services (LBS) device.

In some example embodiments, the gateway device 100 may include an RJ45 connector that is electrically coupled to PoE circuit 112. For example, an Ethernet cable (e.g., CAT 5e cable) may be coupled to the RJ45 connector of the gateway device 100 to provide power to the gateway device 100 from a PoE power supply. The PoE circuit 112 may be coupled to the other components of the gateway device 100 to provide power the components. In some alternative embodiments, the gateway device 100 may include an additional or alternative power circuit without departing from the scope of this disclosure.

In some example embodiments, the processor 102 may be coupled by electrical connections (e.g., electrical wires and/or traces) to the lighting network interface circuit 104, the location-based network interface circuit 106, and the data network interface circuit 108. For example, the processor 102 may control operations of the lighting network interface circuit 104, the location-based network interface circuit 106, and the data network interface circuit 108 based on executable software code. For example, the processor 102 may execute software code stored in the memory device 110 and/or in another memory device to control operations of the gateway device 100.

In some example embodiments, the lighting network interface circuit 104 is designed to communicate with lighting devices over a lighting device communication network. For example, the lighting network interface circuit 104 may include a transceiver that is designed to transmit and receive wireless signals. To illustrate, the lighting network interface circuit 104 may transmit and receive wireless signals that are compliant with IEEE 802.15.4. For example, the lighting network interface circuit 104 may transmit and receive wireless signals that are compliant with ZigBee, Thread, or another protocol (e.g., a proprietary protocol) that is based on IEEE 802.15.4.

The lighting network interface circuit 104 may process received wireless signals and perform operations based on the received wireless signals. The lighting network interface circuit 104 may also communicate with the processor 102 and perform operations based on the communication with the processor 102. For example, the lighting network interface circuit 104 may transmit wireless signals based on instructions from the processor 102. To illustrate, the lighting network interface circuit 104 may include a microcontroller and a memory device to perform operations such as communicate with the processor 102, process information received from the processor 102 or received wirelessly, and communicate wirelessly with lighting devices and other devices over the wireless communication network.

In some example embodiments, the wireless signals received by the lighting network interface circuit 104 of the gateway device 100 may include status information corresponding to lighting devices such as luminaries, wall stations, receptacles, relays, standalone or luminaire integrated occupancy sensors and daylight sensors, etc. The lighting network interface circuit 104 may also transmit wireless signals to the lighting devices to control operations of lighting devices. For example, the lighting network interface circuit 104 may transmit lighting commands wirelessly to turn on, turn off, flash, dim, change color, etc. lights emitted by one or more lighting devices.

In some example embodiments, the location-based network interface circuit 106 is designed to communicate with asset tags over a wireless communication network that is separate from the lighting device communication network. For example, the location-based network interface circuit 106 may include a transceiver that is designed to transmit and receive wireless signals. As a non-limiting example, the location-based network interface circuit 106 may be based on Texas Instruments' SoC, CC2541. To illustrate, the location-based network interface circuit 106 may transmit and receive wireless signals that are compliant with IEEE 802.15.1. For example, the location-based network interface circuit 106 may transmit and receive wireless signals that are compliant with a Bluetooth standard (e.g., Bluetooth 5.0, Bluetooth Low Energy, etc.) or another protocol (e.g., a proprietary protocol) that is based on IEEE 802.15.1.

The location-based network interface circuit 106 may process received wireless signals and perform operations based on the received wireless signals. The location-based network interface circuit 106 may also communicate with the processor 102 and perform operations based on the communication with the processor 102. For example, the location-based network interface circuit 106 may transmit wireless signals based on instructions from the processor 102. To illustrate, the location-based network interface circuit 106 may include a microcontroller and a memory device to perform operations such as communicate with the processor 102, process information received from the processor 102 or received wirelessly, and communicate wirelessly with asset tags and mobile devices over the wireless communication network.

In some example embodiments, a wireless signal received by the location-based network interface circuit 106 of the gateway device 100 may be a beacon signal that includes the identification information of a particular asset tag that transmitted the wireless signal. For example, an asset tag that is carried by or otherwise physically attached to a particular asset may transmit a beacon signal that is compliant with IEEE 802.15.1 (e.g., a Bluetooth beacon signal) indicating the identification information of the asset tag or the identification information of the asset, or both. The location-based network interface circuit 106 of the gateway device 100 may receive the beacon signal and process the beacon signal to determine the asset and/or the asset tag indicated by the beacon signal. Alternatively, the location-based network interface circuit 106 may transfer the identification information to the processor 102, and the processor 102 may process the identification information to determine the asset, the asset tag, or both indicated by the identification information.

Alternatively or in addition, the wireless signal received by the location-based network interface circuit 106 of the gateway device 100 may be a signal sent by an asset tag as a response to a beacon signal sent by the location-based network interface circuit 106 of the gateway device 100. For example, the response signal may include the identification information of the asset tag.

In some example embodiments, the gateway device 100 may process the wireless signal received by the location-based network interface circuit 106 to determine or estimate the location of the asset tag and the asset associated with the asset tag. For example, the location-based network interface circuit 106 may process the wireless signal to determine the signal strength of the wireless signal. The location-based network interface circuit 106 or the processor 102 may determine or estimate the location of the asset tag that transmitted the wireless signal based on the signal strength of the wireless signal received by the location-based network interface circuit 106. The gateway device 100 may perform operations based on the identification information and the signal strength of the wireless signal. For example, the processor 102 may control the lighting network interface circuit 104 to transmit one or more lighting control commands to one or more luminaires, to an exit sign or emergency fixture, etc. to turn on, turn off, flash, change color, and/or change intensity level of respective one or more lights.

In some example embodiments, a wireless signal received by the location-based network interface circuit 106 of the gateway device 100 may be a beacon signal or another signal (e.g., a signal sent in response to a beacon signal sent by the location-based network interface circuit 106) that includes identification information of a particular mobile device (e.g., a mobile phone). The wireless signal may also include location information of the mobile device. For example, the mobile device may determine its location based on location information or identification information received from a luminaire that is near the mobile device.

To illustrate, the mobile device may receive identification information (e.g., luminaire #10) from a particular luminaire, for example, via a visible light communication signal or a Bluetooth signal, and may wirelessly transmit the luminaire identification information. The location-based network interface circuit 106 may receive the identification information from the mobile device and the gateway device 100 may process the luminaire identification information to determine the location of the luminaire based on, for example, stored information associating luminaires with their respective locations.

Alternatively, the mobile phone may receive location information from the luminaire and wirelessly transmit the location information. For example, the luminaire may be aware of its location based on information previously received from the gateway device 100 and transmit the location information of the luminaire to the mobile device, for example, using a visible light communication signal or a Bluetooth signal. The mobile device may transmit the location information of the luminaire along with the identification information of the mobile device, and the location-based network interface circuit 106 of the gateway device 100 may receive the information. The gateway device 100 may process the location and identification information and perform operations based on the information. For example, the processor 102 may control the lighting network interface circuit 104 to transmit one or more lighting control commands to one or more lighting devices (e.g., luminaires, an exit sign or emergency fixture, etc.) to turn on, turn off, flash, change color, and/or change intensity level of respective one or more lights. As another example, the gateway device 100 may transmit to the mobile device information that is relevant to the mobile device user based on the location of the mobile device.

In some example embodiments, the data network interface circuit 108 is designed to communicate with a management device, such as an enterprise management laptop, over a data communication network. For example, the data network interface circuit 108 may include a Wi-Fi circuit 114 and an Ethernet circuit 116. The Wi-Fi circuit 114 may include a transceiver that is designed to transmit and receive wireless signals that are compliant with an IEEE 802.11 standard, such as the IEEE 802.11 b/g/n. The Ethernet circuit 116 may include a transceiver to transmit and receive signals that are compliant with IEEE 802.3 over a wired connection (e.g., over an Ethernet cable such as a CAT 5e).

The data network interface circuit 108 may process wireless signals received by the Wi-Fi circuit 114 and perform operations based on the received wireless signals. The data network interface circuit 108 may also process signals received by the Ethernet circuit 116 and perform operations based on the received signals. The data network interface circuit 108 may also communicate with the processor 102 and perform operations based on the communication with the processor 102. For example, the data network interface circuit 108 may transmit signals based on instructions from the processor 102. To illustrate, the data network interface circuit 104 may include a microcontroller and a memory device to perform operations such as communicate with the processor 102, process information received from the processor 102, process information received wirelessly by the Wi-Fi circuit 114, process information received by the Ethernet circuit 116, and communicate wirelessly and/or via a wired connection over a data communication network with, for example, an enterprise management device. For the processor 102 may control the data network interface circuit 108 to transmit information received by the lighting network interface circuit 104 and information received by the location-based network interface circuit 106 to a management or another device over a data communication network.

In some example embodiments, the wireless signals received by the lighting network interface circuit 104 of the gateway device 100 may include status information corresponding to lighting devices such as luminaries, wall stations, receptacles, relays, standalone or luminaire integrated occupancy sensors and daylight sensors, etc. The lighting network interface circuit 104 may also transmit wireless signals to the lighting devices to control operations of lighting devices. In some example embodiments, the lighting network interface circuit 104 and the location-based network interface circuit 106 may transmit wireless signals based on information received by the Wi-Fi circuit 114 and/or the Ethernet circuit 116 over a data communication network. For example, the lighting network interface circuit 104 may wirelessly transmit lighting commands to turn on, turn off, flash, dim, change color, etc. lights emitted by one or more lighting devices based on an instruction received by the data network interface circuit 108. As another example, the location-based network interface circuit 106 may wirelessly transmit commands to one or more asset tags, for example, to vibrate or blink a light, based on an instruction received by the data network interface circuit 108.

In some example embodiments, the processor 102 may control the lighting network interface circuit 104 to transmit a lighting control command based on identification information wirelessly received by the location-based network interface circuit 106. For example, the gateway device 100 may transmit a lighting control command to a luminaire that is near the asset tag corresponding to the received asset identification information. To illustrate, the lighting control command may instruct the luminaire to turn on its light, turn of its light, dim, change color, etc. As another example, the gateway device 100 may transmit a lighting control command to a luminaire that is at a particular location, such as a security office or at an exit from a building, for example, to alert others that the asset associated with an asset tag may be leaving a designated area.

In some example embodiments, the processor 102 may control the location-based network interface circuit 106 to wirelessly transmit an asset tag control command based on information received by the data network interface circuit 108. For example, the data network interface circuit 108 may receive information from an enterprise management device (e.g., a laptop computer) over a data network that indicates that a particular asset tag should vibrate, blink a light of the tag, etc. and the processor 102 may control the location-based network interface circuit 106 to wirelessly transmit an asset tag control command to the particular asset tag to vibrate, blink an LED light of the asset tag, etc.

In some example embodiments, the processor 102 may control the location-based network interface circuit 106 to transmit an asset tag control command based on information wirelessly received by the lighting network interface circuit 104. For example, the lighting network interface circuit 104 may receive a message transmitted wirelessly by a wall station, and the processor 102 may control the location-based network interface circuit 106 to transmit a command to an asset tag associated with the received message.

In some example embodiments, the processor 102 may control the location-based network interface circuit 106 to transmit an asset tag control command based on identification information wirelessly received by the location-based network interface circuit 106. For example, when the location-based network interface circuit 106 receives a beacon signal including the identification information of the transmitting asset tag, the processor 102 or the location-based network interface circuit 106 may determine whether the asset tag is outside of a particular boundary, for example, based on the signal strength of the beacon signal. If the asset tag is outside of or near the particular boundary, the processor 102 may control the location-based network interface circuit 106 to transmit an alert command (e.g., a vibrate command) to the asset tag to alert the asset attached to the assert tag. For example, the asset may be a person, and the processor 102 may control the location-based network interface circuit 106 to transmit a command to the asset tag carried by the person as an alert that the person is, for example, outside of an authorized area.

By having the three separate network interfaces, the gateway device 100 enables the different networks to operate independently as well as to interoperate with each other. The gateway device 100 enables coordination between the three different networks with respect to events on one of the networks. For example, two of the three network interface circuits may transmit respective signals on their respective networks in response to the third network interface circuit receiving information over the corresponding network. The gateway device 100 enables three separate networks, which can minimize the demand on one particular network. In some example embodiments, the gateway device 100 may support location-based devices that are within 30 to 100 feet. In some alternative embodiments, the range may be extended by using other standards.

Although particular components and connections of the gateway device 100 are shown in FIG. 1, in alternative embodiments, the gateway device 100 may be implemented using different components and connections without departing from the scope of this disclosure. In some example embodiments, one or more of the components of the gateway device 100 may be integrated into a single component without departing from the scope of this disclosure. Although particular three networks are described above in association with particular communications standards, in some alternative embodiments, one or more the networks may be associated with a different communications standard without departing from the scope of this disclosure.

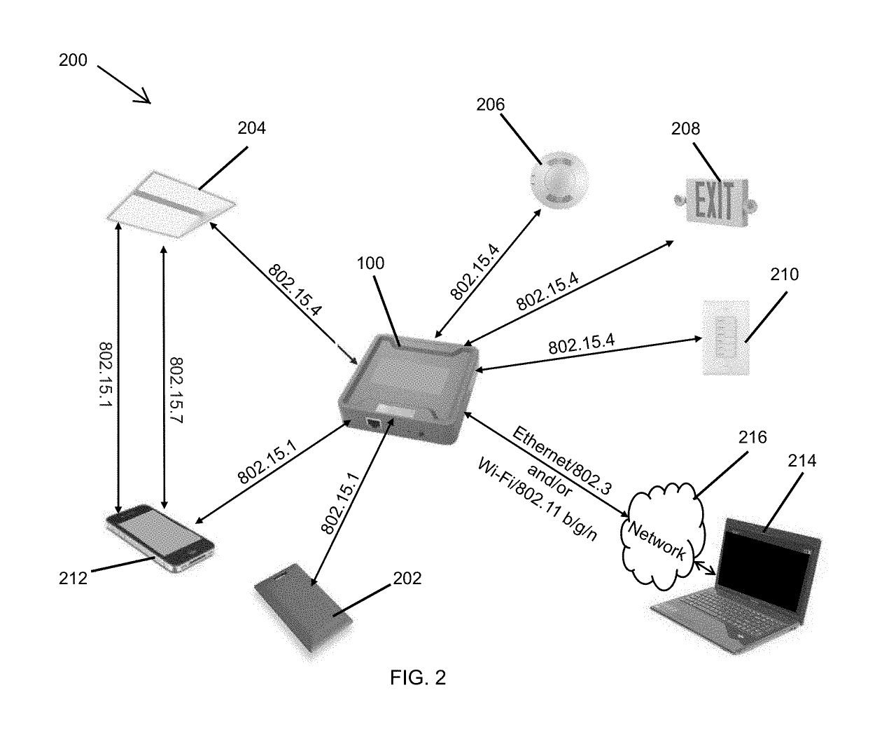

FIG. 2 illustrates a multi-network system 200 that includes the multi-network gateway device 100 of FIG. 1 according to an example embodiment. Referring to FIGS. 1 and 2, in some example embodiments, the system 200 includes an asset tag 202, a luminaire 204, a sensor 206, an exit sign/emergency fixture 208, and a wall station 210. The system 200 may also include a mobile device 212 that can communicate with the gateway device 100 as well as with the luminaire 204. The gateway device 100 may communicate with an enterprise management device 214, for example, via a network 216. The network 216 may include a Wi-Fi network, an Ethernet network, another type of wired or wireless network, and/or the Internet. The data network interface circuit 108 of the gateway device 100 may transmit to and receive from the enterprise management device 214 wireless signals that are compliant with an IEEE 802.11 standard. Alternatively or in addition, the data network interface circuit 108 of the gateway device 100 may transmit to and receive from the enterprise management device 214 signals that are compliant with the IEEE 802.3 standard.

In some example embodiments, the asset tag 202 may be an active tag that can transmit wireless signals compliant with IEEE 802.15.1 standard. For example, the asset tag 202 may be attached to an asset such as a person or equipment. In general, the gateway device 100 and the asset tag 202 may communicate with each other using IEEE 802.15.1 compliant wireless signals, such as Bluetooth signals or other wireless signals that are compliant with the IEEE 802.15.1 standard.

In some example embodiments, the asset tag 202 may transmit a wireless beacon signal that includes identification information of the asset tag 202. The location-based network interface circuit 106 of the gateway device 100 may receive the wireless signals transmitted by the asset tag 202, and the gateway device 100 may determine the identity of the asset tag 202 and determine or estimate the location of the asset tag 202 from the received signals. For example, the gateway device 100 may determine or estimate the location of the asset tag 202 based on the signal strength of the wireless signals. Alternatively or in addition, the gateway device 100 may rely on directional antennas and Multiple-Input Multiple-Output (MIMO) technology to determine location of the asset tag 202. The gateway device 100 may also coordinate with other gateway devices (i.e., other instances of the gateway device 100) to determine the location of the asset tag 202 based on, for example, time of flight of the wireless signals from the asset tag 202 to each of the gateway devices. In response to determining or estimating the location of the asset tag 202, the gateway device 100 may transmit the information to the enterprise management device 214 over the network 216 or may transmit asset tag commands (e.g., vibrate, blink light, etc.) to the asset tag 202 or lighting commands (e.g., turn on, off, flash, etc.) to one or more lighting devices such as the luminaire 1204, the sensor 206, and/or the exit sign/emergency fixture 208. In some alternative embodiments, the gateway device 100 may transmit received information to the enterprise management device 214 over the network 216, and the enterprise management device 214 may determine or estimate the location of the asset tag 202.

In some example embodiments, the luminaire 1204, the sensor 206, the exit sign/emergency fixture 208, and the wall station 210 communicate with the gateway device 100 over a lighting device communication network using wireless signals that are compliant with IEEE 802.15.4 standard. For example, the lighting network interface circuit 104 may transmit to and receive from the luminaire 1204, the sensor 206, the exit sign/emergency fixture 208, and the wall station 210 wireless signals that are compliant with ZigBee, Thread, or another protocol (e.g., a proprietary protocol) that is based on IEEE 802.15.4. To illustrate, the gateway device 100 may receive information (e.g., status of the sensor 206) and transmit commands (e.g., a lighting command to turn off the light emitted by the luminaire 204) using wireless signals that are compliant with the IEEE 802.15.4 standard.

In some example embodiments, the mobile device 212 may communicate with the luminaire 204 using visible light communication (VLC) signals (e.g., VLC signals that are compliant with IEEE 802.15.7). For example, when the mobile device 212 is near the luminaire 204, the luminaire 204 may communicate the identity of the luminaire 204 to the mobile device using a VLC signal, and the mobile device 212 may wirelessly transmit the identity of the luminaire 204 along with the identification information of the mobile device 212 to the gateway device 100 using Bluetooth or other signals that are compliant with the IEEE 802.15.1 standard. The gateway device 100 may already have the information that associates the identity of the luminaire 204 with its respective location, for example, based on commissioning operations.

By determining the location of the luminaire 202, the gateway device 100 may determine or estimate the location of the mobile device 212. In some alternative embodiments, the gateway device 100 may transmit the luminaire identity information and the identification information of the mobile device 212, both received from the mobile device 212, to the enterprise management device 214 over the network 216, and the enterprise management device 214 may determine or estimate the location of the mobile device 212. In response to the location of the mobile device 212 being determined either by the gateway device 100 or by the enterprise management device 214, relevant information may be sent to the mobile device 212 by the gateway device 100 using, for example, Bluetooth signals. Alternatively or in addition, an asset tag command (e.g., a vibrate command) may be sent to the asset tag 202 to alert, for example, a person (carrying or wearing the asset tag 202) that is near the mobile device 212. The gateway device 100 may also send a lighting command, for example, to the luminaire 204 instead of or in addition to the asset tag command sent to the asset tag 202.

In some example embodiments, the luminaire 204 may communicate the identity of the luminaire 204 (and/or other information) to the mobile device 212 using Bluetooth signals instead of or in addition to VLC signals. The mobile device 212 may communicate the information received from the luminaire 204 along with the identification information of the mobile device 212 to the gateway device 100 in the same manner as described above. The gateway device 100 may process the information to determine or estimate the location of the mobile device 212. Alternatively, the gateway device 100 may transfer the information to the enterprise management device 214 over the network 216, and the enterprise management device 214 may determine or estimate the location of the mobile device 212. In response to the location of the mobile device 212 being determined either by the gateway device 100 or by the enterprise management device 214, relevant information may be sent to the mobile device 212 by the gateway device 100 using, for example, Bluetooth signals. Alternatively or in addition, a command (e.g., a vibrate command) may be sent to the asset tag 202 to alert, for example, a person (carrying or wearing the asset tag 202) that is near the mobile device 212. The gateway device 100 may also send a lighting command, for example, to the luminaire 204 instead of or in addition to the asset tag command sent to the asset tag 202.

Although particular system elements are shown in FIG. 2, in alternative embodiments, the system 200 may include other elements such as other lighting devices, other mobile devices, and other tags without departing from the scope of this disclosure. In some alternative embodiments, the system 200 may include multiple gateway devices 100. In some example embodiments, some of the system elements shown in FIG. 2 may be omitted without departing from the scope of this disclosure. In some alternative embodiments, the asset tag 202 may have a different dimensions, shape, etc. than shown in FIG. 2 without departing from the scope of this disclosure.

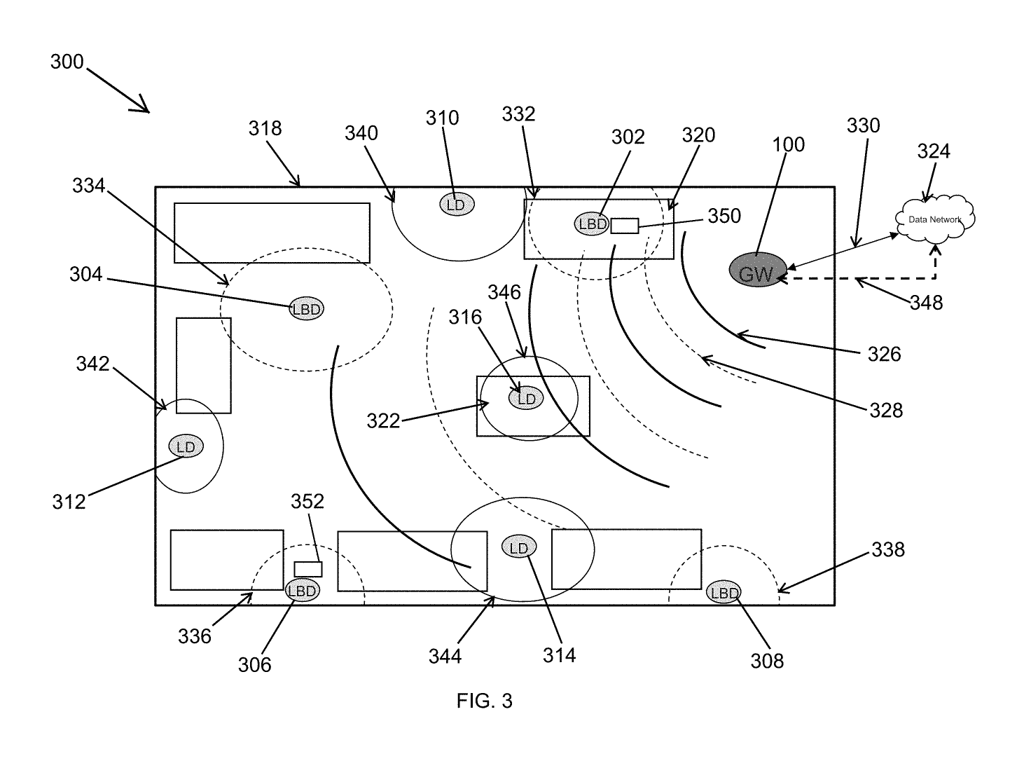

FIG. 3 illustrates a multi-network system 300 that includes the multi-network gateway 100 of FIG. 1 according to another example embodiment. Referring to FIGS. 1-3, in some example embodiments, the system 300 includes the gateway device 100, location-based devices 302, 304, 306, 308, and lighting devices 310, 312, 314, 316. One or more of the location-based devices 302, 304, 306, 308 may each be an asset tag, similar to the asset tag 202 shown in FIG. 2, and the remaining ones or more of the location-based devices 302, 304, 306, 308 may be a mobile device, such as a mobile phone. For example, the location-based device 302 may be an asset tag that is carried by or attached to an asset 350 (e.g., a person, lap equipment, hospital equipment, etc.). As another example, the location-based device 306 may be an asset tag that is carried by or attached to an asset 352.

In some example embodiments, the system 300 may be deployed in building 318 that includes rooms such as room 320, 322. Alternatively, the system 300 may be implemented in a different structure. In some example embodiments, the gateway device 100 may communicate with a device such as the enterprise management device 214 over a network 324 using Wi-Fi signals 330 or Ethernet signals 348.

In some example embodiments, the gateway device 100 may transmit wireless signals 326 that are compliant with an IEEE 80215.4 standard. The lighting device 310 may transmit wireless signals 340, the lighting device 312 may transmit wireless signals 342, the lighting device 314 may transmit wireless signals 344, and the lighting device 316 may transmit wireless signals 346. The wireless signals 340, 342, 344, 346 may also be compliant with an IEEE 80215.4 standard such that the gateway device 100 may receive and process these signals. The lighting devices 310, 312, 314, 316 may also receive and process the wireless signals 326 transmitted by the gateway device 100.

In some example embodiments, the gateway device 100 may transmit wireless signals 328 that are compliant with an IEEE 80215.1 standard. The location-based device 302 may transmit wireless signals 332, the location-based device 304 may transmit wireless signals 334, the location-based device 306 may transmit wireless signals 336, and the location-based device 308 may transmit wireless signals 338. The wireless signals 332, 334, 336, 338 may also be compliant with an IEEE 80215.1 standard such that the gateway device 100 may receive and process these signals. The location-based devices 302, 304, 306, 308 may also receive and process the wireless signals 328 transmitted by the gateway device 100.

In some example embodiments, one or more of the lighting devices 310, 312, 314, 316 may be located in a room within the building 318. For example, the lighting device 316 may be in the room 322, such as a security monitoring room. To illustrate, a gateway device 100 may send a lighting command to the lighting device 316 (e.g., a luminaire) to flash or otherwise change the light emitted by the lighting device 316 in order to alert a person that is the room 322, for example, in response to determining that one of the location-based devices 302, 304, 306, 308 has moved outside of the building 318 or outside of a particular room. For example, the gateway device 100 may send a lighting command to the lighting device 316 in response to determining that the location-based device 302 has moved out of the room 320. The gateway device 100 may also send lighting commands to one or more other lighting devices when one or more of the location-based devices 302, 304, 306, 308 moves outside of a designated area. The gateway device 100 or the enterprise management device 214 may determine or estimate the locations of the location-based devices 302, 304, 306, 308 based on, for example, the signal strengths of the wireless signals transmitted by the location-based devices 302, 304, 306, 308.

In some example embodiments, one or more of the location-based devices 302, 304, 306, 308 may be a mobile device, and the gateway device 100 may transmit information to the particular one or more of the location-based devices 302, 304, 306, 308 to guide, for example, a person carrying the device(s) to an exit or to another location based on the location of the particular one or more of the location-based devices 302, 304, 306, 308. For example, the location-based device 304 may be a mobile device (e.g., a mobile phone) and the gateway device 100 may transmit direction information to the location-based device 304 after the gateway device 100 or the enterprise management device 214 determines or estimates the location of the location-based device 304.

In some alternative embodiments, the system 300 may include more or fewer location-based devices and/or lighting devices than shown without departing from the scope of this disclosure. In some alternative embodiments, the location-based devices 302, 304, 306, 308 and the lighting devices 310, 312, 314, 316 may be at different locations than shown without departing from the scope of this disclosure.

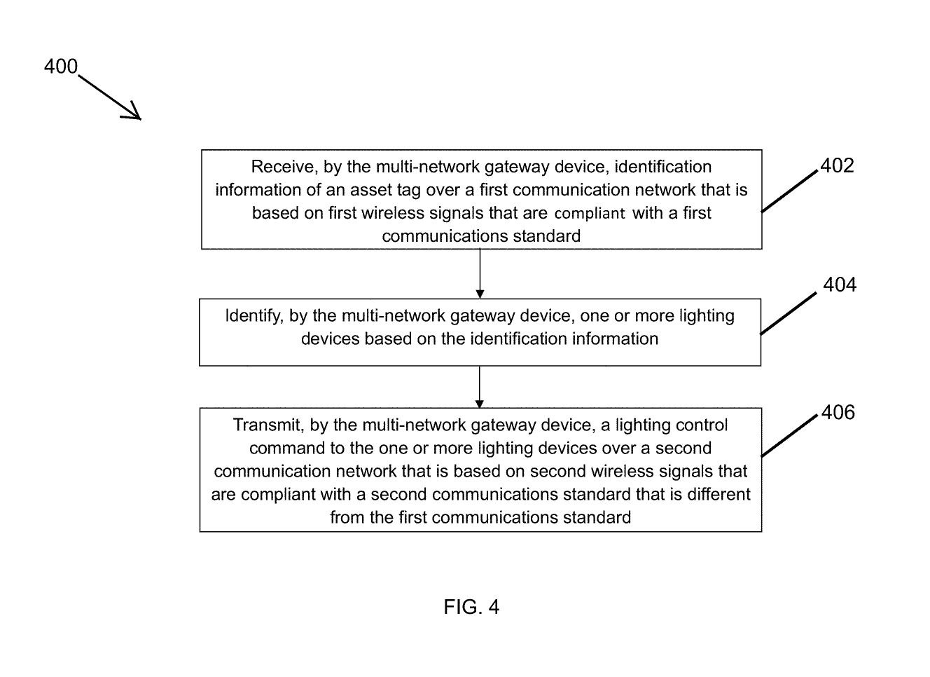

FIG. 4 illustrates a method 400 of operating the multi-network gateway device 100 and systems 200, 300 of FIGS. 1-3 according to an example embodiment. Referring to FIGS. 1-4, at step 402, the method 400 includes receiving, by the multi-network gateway device 100, identification information of an asset tag, where the multi-network gateway device 100 receives the identification information over a communication network that is based on wireless signals that are compliant with a first communications standard, such as IEEE 802.15.1 standard (e.g., Bluetooth). For example, the gateway device 100 may receive identification information of the asset tag 302 from the asset tag 302. The asset tag 302 may be attached to or carried by an asset, such as the asset 350 shown in FIG. 3, and the identification information of the asset tag 302 may be associated with the asset.

At step 404, the method 400 may include identifying, by the multi-network gateway device 100, one or more lighting devices based on the identification information. For example, in response to receiving the identification information of an asset tag, the gateway device 100 may identify a luminaire that is near the asset tag, and thus, near the asset associated with the asset tag. For example, the gateway device 100 may determine or estimate the location of the asset tag based on the wireless signals received from the asset tag, and identify a luminaire or another lighting device that is near the asset tag. Alternatively, in response to receiving the identification information, the gateway device 100 may identify a luminaire or another lighting device that is at another location, such as a security monitoring room, etc. For example, the gateway device 100 may use information stored in the gateway device 100, such locations of lighting devices, to process the identification information and identify the relevant luminaires and/or other lighting devices.

At step 406, the method 400 may include transmitting, by the multi-network gateway device 100, a lighting control command to the one or more lighting devices over a communication network that is based on wireless signals that are compliant with an IEEE 802.15.4 standard. The method 40 may also include transmitting, by the multi-network gateway device, the received identification information to a management device (e.g., the enterprise management device 214) over a data communication network, such as a Wi-Fi network or an Ethernet network.

In some example embodiments, the method 400 may include other steps before, between, or after the steps described above.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A multi-network gateway device, comprising:
a lighting network interface circuit configured to communicate with lighting devices using first wireless signals compliant with a first communications standard;
a location-based network interface circuit configured to communicate with asset tags using second wireless signals compliant with a second communications standard that is different from the first communications standard; and
a processor configured to control the lighting network interface circuit to transmit a lighting control command based on identification information received wirelessly by the location-based network interface circuit.

2. The gateway device of claim 1, further comprising a data network interface circuit configured to communicate using third signals compliant with a third communications standard.

3. The gateway device of claim 2, wherein the third communications standard is a Wi-Fi standard or an Ethernet standard.

4. The gateway device of claim 2, wherein the processor is further configured to control the data network interface circuit to transmit by the gateway device first information received by the lighting network interface circuit and second information received by the location-based network interface circuit.

5. The gateway device of claim 2, wherein the processor is further configured to control the location-based network interface circuit to wirelessly transmit by the gateway device an asset tag control command based on information received by the data network interface circuit over a data network.

6. The gateway device of claim 1, wherein the processor is further configured to control the location-based network interface circuit to wirelessly transmit an asset tag control command based on information wirelessly received by the lighting network interface circuit.

7. The gateway device of claim 1, wherein the processor is further configured to control the location-based network interface circuit to wirelessly transmit an asset tag control command based on the identification information wirelessly received by the location-based network interface circuit.

8. The gateway device of claim 1, wherein the first communications standard is an IEEE 802.15.4 standard.

9. The gateway device of claim 1, wherein the second communications standard is an IEEE 802.15.1 standard.

10. The gateway device of claim 9, wherein the location-based network interface circuit is further configured to communicate with a mobile device using third wireless signals compliant with the second communications standard.

11. A multi-network system, comprising:
a gateway device having a lighting network interface and a location-based network interface;
a lighting device that wirelessly communicates with the gateway device using first wireless signals compliant with a first communications standard; and
an asset tag that wirelessly communicates with the gateway using second device wireless signals compliant with a second communications standard that is different from the first communications standard, wherein the gateway device transmits a lighting control command to the lighting device via the lighting network interface based on identification information wirelessly received by the gateway device via the location-based network interface.

12. The system of claim 11, wherein the first communications standard is an IEEE 802.15.4 standard.

13. The system of claim 11, wherein the second communications standard is an IEEE 802.15.1 standard.

14. The system of claim 11, further comprising a mobile device that wirelessly communicates with the gateway device using third wireless signals compliant with the second communications standard.

15. The system of claim 11, wherein a data network interface of the gateway device transmits, to a management device, first information received wirelessly from the lighting device and second information received wirelessly from the asset tag.

16. A method of communication by a multi-network gateway device, comprising:
receiving, by the multi-network gateway device, identification information of an asset tag over a first communication network that is based on first wireless signals that are compliant with a first communications standard;
identifying, by the multi-network gateway device, one or more lighting devices based on the identification information; and
transmitting, by the multi-network gateway device, a lighting control command to the one or more lighting devices over a second communication network that is based on second wireless signals that are compliant with a second communications standard that is different from the first communications standard.

17. The method of claim 16, further comprising estimating a location of the asset tag, wherein identifying the one or more lighting devices based on the identification information comprises identifying the one or more lighting devices based on the location of the asset tag.

18. The method of claim 16, further comprising transmitting, by the multi-network gateway device, the identification information to a management device over a data communication network.

19. The method of claim 18, wherein the first communications standard is an IEEE 802.15.1 standard, wherein the second communications standard is an IEEE 802.15.4 standard, and wherein the data communication network is based on a Wi-Fi standard or an Ethernet standard.

20. The method of claim 16, further comprising receiving, by the multi-network gateway device, location information from a mobile device over the first communication network.
